(19) United States
(12) Patent Application Publication
(10) Pub. No.: US 2008/0082704 A1
(43) Pub. Date: Apr. 3, 2008

(54) Data processing apparatus for data transmission and reception and data transfer method for data transfer system including the data processing apparatus

(75) Inventors: Shuuji Takahashi, Kanagawa (JP); Kunio Niwa, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELETRONICS CORPORATION, Kawasaki (JP)

(21) Appl. No.: 11/905,367

(22) Filed: Sep. 28, 2007

(30) Foreign Application Priority Data
Sep. 29, 2006 (JP) 267976/2006

(51) Int. Cl. G06F 13/12

(52) U.S. Cl. 710/61

(57) ABSTRACT

A data transfer system includes a transceiver and a data processing apparatus coupled to the transceiver through a first line, a second line, and a third line. A data transfer method for the data transfer system includes, when data is transferred from the transceiver to the data processing apparatus, transmitting a first trigger signal from the data processing apparatus to the transceiver through the first line, transmitting a first clock signal from the transceiver to the data processing apparatus through the second line in response to the first trigger signal, and transmitting first transfer data from the transceiver to the data processing apparatus through the third line in synchronization with the first clock signal. On the other hand, the data transfer method includes, when data is transferred from the data processing apparatus to the transceiver, transmitting a second trigger signal from the data processing apparatus to the transceiver through the first line, transmitting a second clock signal from the transceiver to the data processing apparatus through the second line in response to the second trigger signal, and transmitting second transfer data from the data processing apparatus to the transceiver in synchronization with the second clock signal. According to such a data transfer method for the data transfer system, the handshake signal output side is not changed between the data transmission side and the data reception side and one signal line is used to transfer the handshake signal. Therefore, the data transfer can be performed by the data transfer system simpler than the conventional data transfer system.

### BACKGROUND OF THE INVENTION

1. Field of the Invention The present invention relates to a data processing apparatus and a data transfer method for a data transfer system including the data processing apparatus, and more particularly, to a data processing apparatus for data transmission and reception and a data transfer method for a data transfer system including the data processing apparatus.

2. Description of the Related Art

Examples of a data-rewritable nonvolatile memory include an electrically erasable programmable read only memory (EEPROM) in which data can be rewritten on a byte-by-byte basis and a flash memory in which data can be rewritten on a block-by-block basis. A microcomputer (micon) containing the nonvolatile memory stores various data and programs which are used for user systems in the contained nonvolatile memory. When the data and the programs are written into the nonvolatile memory contained in the microcomputer, data transfer using a handshake communication system has been used.

The handshake communication system is a system in which a transmission side starts data transfer in response to an acknowledgment signal (ACK) from a reception side when the data transfer is to be performed from the transmission side to the reception side. According to the handshake communication system, highly reliable communication can be performed.

A technique for writing data into a microcomputer containing a flash memory (flash microcomputer) using the handshake communication system is disclosed in JP 2001-357690 A. FIG. 8 is a block diagram showing a flash write apparatus 80 described in JP 2001-357690 A. The flash write apparatus 80 includes a flash writer 81 and a flash microcomputer 82. The flash microcomputer 82 includes a serial transmission and reception section 83, a port section 84, a flash memory section 85, and a control section 86. The control section 86 includes a serial transmission and reception control section 87, a port control section 88, and a flash memory control section 89, each being a sub-block.

In the case of three-wire serial communication, four communication lines including a handshake leased line for transmission and reception of a handshake signal are connected between the flash writer 81 and the flash microcomputer 82. In FIG. 8, a line for serial clock output from the flash writer 81 to the serial transmission and reception section 83, a line for data output from the flash writer 81 to the serial transmission and reception section 83, and a line for data output from the serial transmission and reception section 83 to the flash writer 81 are connected between the flash writer 81 and the serial transmission and reception section 83. The line for transmission and reception of the handshake signal is connected between the flash writer 81 and the port section 84. The flash writer 81 executes writing to the flash memory section 85 included in the flash microcomputer 82 through the four communication lines.

In FIG. 8, before write data transfer from the flash writer 81 to the flash memory section 85, a handshake terminal for transmission and reception of the handshake signal is determined from a plurality of terminals managed by the port section 84. In order to determine the handshake terminal, the flash writer 81 transmits a serial clock signal, a handshake set command, and handshake terminal information to the serial transmission and reception section 83. The serial transmission and reception section 83 outputs the received handshake set command and the received handshake terminal information to the control section 86. The serial transmission and reception control section 87 of the control section 86 transmits an ACK signal indicating that the handshake set command and the handshake terminal information are normally received to the flash writer 81 through the serial transmission and reception section 83. The port control section 88 of the control section 86 determines one of the plurality of terminals of the port section 84 as the handshake terminal based on the handshake terminal information.

A handshake communication enable state is set by the above operation. In the flash write apparatus 80 described in JP 2001-357690 A, data is written from the flash memory 81 into the flash memory section 85 included in the flash microcomputer 82 by the handshake communication system using the handshake leased line.

A technique for performing data transmission without using the handshake leased line for data transfer between a slave device and a master device is disclosed in JP 2001-274862 A. FIG. 9 shows a connection relationship between a slave device 90 and a master device 91 as described in JP 2001-274862 A. The slave device 90 has a slave output terminal (SO), a slave input terminal (SI), a slave clock terminal (SCLK), and an external interrupt input terminal (Ext Int). The master device 91 has a master input terminal (MI), a master output terminal (MO), and a master clock terminal (MCLK).

The slave device 90 and the master device 91 are connected with each other through three lines. The slave output terminal SO and the master input terminal MI are connected with each other through a bus line SD, and slave data (SD) is transmitted from the slave device 90 to the master device 91 through the bus line SD. The slave input terminal SI and the master output terminal MO are connected with each other through a bus line MD, and master data (MD) is transmitted from the master device 91 to the slave device 90 through the bus line MD. The slave clock terminal SCLK and the master clock terminal MCLK are connected with each other through a bus line CLK, and a clock (CLK) is transmitted from the master device 91 to the slave device 90 through the bus line CLK. The external interrupt input terminal (Ext Int) is connected with the master output terminal MO and used to improve the responsiveness of the slave device 90.

Next, a method of performing data transfer between the slave device 90 and the master device 91 as shown in FIG. 9 will be described.. FIG. 10 shows the case where data are transmitted from the slave device 90 to the master device 91. An initial value of each of the slave data SD and the master data MD is set to an “H” level. Eight bits are used for data transmission. In FIG. 10, data transmission of H7 to H0 and data transmission of A7 to A0 are performed.

First, at a time t0, the slave device 90 changes the level of the bus line SD from the “H” level to an “L” level to transmit an edge signal to the master device 91. At a time t1 after the lapse of a period T1 for synchronization, the master device 91 detects the edge signal on the bus line SD and shifts to a receiving mode, so that the level of the bus line MD is set from the “H” level to the “L” level. The generated edge signal is used to send a notice indicating that the master device 91 is in a receivable state to the slave device 90.

At a time t2 after the lapse of a period T2 from the generation of the edge signal on the bus line MD, the master device 91 outputs the clock (CLK) onto the bus line CLK. The slave device 90 outputs data H7 onto the bus line SD in response to the generation of the clock (CLK). At a time t3, the master device 91 obtains the data H7 on the bus line SD at the rising edge of the clock (CLK). Therefore, the data transmission of data H6 to H0 from the slave device 90 to the master device 91 is repeated.

At a time t4, the transfer of the data H0 is completed and the output of the clock (CLK) from the master device 91 is stopped. During a period T3 from the time t4, the master device 91 transfers the obtained data H7 to H0 to a memory (not shown) At a time t5, the master device 91 changes the level of the bus line MD from the “L” level to the “H” level to transmit the edge signal to the slave device 90. Therefore, the slave device 90 determines that the master device 91 is ready for reception. At a time t6, the clock (CLK) is output onto the bus line CLK and data A7 is output onto the bus line SD, thereby starting data transmission. Similarly, data A6 to A0 are transmitted from the slave device 90 to the master device 91.

FIG. 11 shows the case where data are transmitted from the master device 91 to the slave device 90. When the data are to be transmitted from the master device 91 to the slave device 90, the data H7 to H0 and A7 to A0 are transmitted through the bus line MD. In other words, the roles of the bus line SD and the bus line MD are reversed. Other operations are fundamentally identical to those in the case where the data are transmitted from the slave device 90 to the master device 91.

As described above, with respect to the data transfer between the slave device 90 and the master device 91 described in JP 2001-274862 A, the transmission and reception of the handshake signal is performed not through the handshake leased line as disclosed in JP 2001-357690 A but through the two signal lines of the bus line SD and the bus line MD, each of which is a data line used for data transmission. That is, according to JP 2001-274862 A, the transmission side (slave device 90; master device 91) transmits the edge signal which is a request signal for obtaining approval to start data transmission to the reception side (master device 91; slave device 90) through the data line (bus line SD; bus line MD). The reception side detects the edge signal and transmits the edge signal which is an acknowledgment signal (ACK) for acknowledging the data transfer to the transmission side through the data line (bus line MD; bus line SD). The transmission side starts the data transfer in response to the reception of the edge signal as a trigger.

The present inventor has recognized that, in recent years, with a significant increase in capacity of the nonvolatile memory mounted on the nonvolatile-memory-contained microcomputer, it is important to shorten a writing time to the nonvolatile memory. Therefore, it is desirable to realize the simplification of a data transfer system for transfer of data written into the nonvolatile memory and an increase in speed of the data transfer system, thereby simplifying write processing to the nonvolatile memory and increasing a write processing speed.

### SUMMARY

The present invention seeks to solve one or more of the above problems, or to improve upon those problems at least in part.

In one embodiment, a data transfer system includes a transceiver and a data processing apparatus coupled to the transceiver through a first line, a second line, and a third line. A data transfer method for the data transfer system includes, when data is transferred from the transceiver to the data processing apparatus, transmitting a first trigger signal from the data processing apparatus to the transceiver through the first line, transmitting a first clock signal from the transceiver to the data processing apparatus through the second line in response to the first trigger signal, and transmitting a first transfer data from the transceiver to the data processing apparatus through the third line in synchronization with the first clock signal. On the other hand, the data transfer method includes, when data is transferred from the data processing apparatus to the transceiver, transmitting a second trigger signal from the data processing apparatus to the transceiver through the first line, transmitting a second clock signal from the transceiver to the data processing apparatus through the second line in response to the second trigger signal, and transmitting a second transfer data from the data processing apparatus to the transceiver in synchronization with the second clock signal.

As described above, in the data transfer method for the data transfer system, when the first transfer data is transmitted from the transceiver to the data processing apparatus and when the second transfer data is transmitted from the data processing apparatus to the transceiver, each of the first and second trigger signals transferred through the first line coupled between the transceiver and the data processing apparatus is used as the handshake signal. That is, in the data transfer method for the data transfer system, the data transfer between the transceiver and the data processing apparatus is realized using only the first line through which the first and second trigger signals are transferred. According to such a data transfer method for the data transfer system, the handshake signal output side is not changed between the data transmission side and the data reception side and one signal line is used to transfer the handshake signal. Therefore, the data transfer can be performed by the data transfer system simpler than the conventional data transfer system.

In another embodiment, a data transfer method for a data transfer system includes a transceiver and a data processing apparatus coupled to the transceiver through a first line, a second line, and a third line. A data transfer method for the data transfer system includes the following steps from (a) to (f):(a) transmitting a first trigger signal from the data processing apparatus to the transceiver through the first line; (b) transmitting a first clock signal from the transceiver to the data processing apparatus through the second line in response to the first trigger signal; (c) transmitting a first transfer data from the transceiver to the data processing apparatus through the third line in synchronization with the first clock signal; (d) transmitting a second trigger signal from the data processing apparatus to the transceiver through the first line after step (c); (e) transmitting a second clock signal from the transceiver to the data processing apparatus through the second line in response to the second trigger signal; and (f) transmitting a second transfer data from the data processing apparatus to the transceiver through the first line in synchronization with the second clock signal.

As described above, in the data transfer method for the data transfer system, the first and second trigger signals, each being the handshake signal, are output from the data processing apparatus through the first line and the handshake signal is not output from the transceiver through the third line. That is, according to the data transfer method for the data transfer system, the handshake signal output side is not changed between the data transmission side and the data reception side. One signal line is used to transfer the handshake signal. Therefore, the data transfer can be performed by the data transfer system simpler than the conventional data transfer system.

In further another embodiment, a data processing apparatus includes a first terminal, a second terminal and a third terminal, in which the data processing apparatus is able to perform data transmission and reception with a transceiver through the first terminal, the second terminal, and the third terminal. When data output from the transceiver is received, the data processing apparatus is configured-to: output a first trigger signal from the first terminal; receive, at the second terminal, a first clock signal output from the transceiver in response to the first trigger signal; and receive, at the third terminal, a first transfer data output from the transceiver in synchronization with the first clock signal. On the other hand, when data is transmitted to the transceiver, the data processing apparatus is configured to: output a second trigger signal from the first terminal; receive, at the second terminal, a second clock signal output from the transceiver in response to the second trigger signal; and output a second transfer data from the first terminal to the transceiver in synchronization with the received second clock signal:

As described above, when the data (first transfer data) is received from the transceiver, the data processing apparatus outputs the first trigger signal to the transceiver to use the first trigger signal as a handshake signal. On the other hand, when the data (second transfer data) is transmitted to the transceiver, the data processing apparatus outputs the second trigger signal to the transceiver to use the second trigger signal as a handshake signal. In other words, the data processing apparatus uses only a single signal line coupled to the first terminal for outputting the first and the second trigger signals to realize data transfer with the transceiver. In a conventional data transfer system, a data reception side outputs a handshake signal through a signal line coupled to an output terminal from which data is not output. That is, in a case where a data transmission side and the data reception side are interchanged in data transmission and reception, a handshake signal output side and a handshake signal reception side are also interchanged. Therefore, the handshake signal output side is changed and two signal lines are used to transfer the handshake signal. In contrast to this, the data processing apparatus has the structure in which the handshake signal is output from any of the transmission side and the reception side at the time of data transmission and reception, so the data transfer can be performed by a data transfer system simpler than the conventional system. As a result, a data transfer speed can be increased and the data processing apparatus can perform a series of operations from the reception of data to the processing of the received data at high speed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a data writing system 10 according to a first embodiment of the present invention;

FIG. 2 is a block diagram showing a flash writer 11 according to the first embodiment of the present invention;

FIG. 3 is a block diagram showing a flash microcomputer 12 according to the first embodiment of the present invention;

FIG. 4 is an operational flowchart showing operations of the flash writer 11 and the flash microcomputer 12 according to the first embodiment of the present invention;

FIG. 5 is a timing chart showing signals transmitted and received between the flash writer 11 and the flash microcomputer 12 according to the first embodiment of the present invention (in the case where normal writing is performed);

FIG. 6 is a timing chart showing signals transmitted and received between the flash writer 11 and the flash microcomputer 12 according to the first embodiment of the present invention (in the case where the normal writing is not performed);

FIG. 7 is a timing chart showing signals transmitted and received between the flash writer 11 and the flash microcomputer 12 according to the first embodiment of the present invention (in the case where write data are successively transmitted);

FIG. 8 is a block diagram showing a conventional flash write apparatus 80;

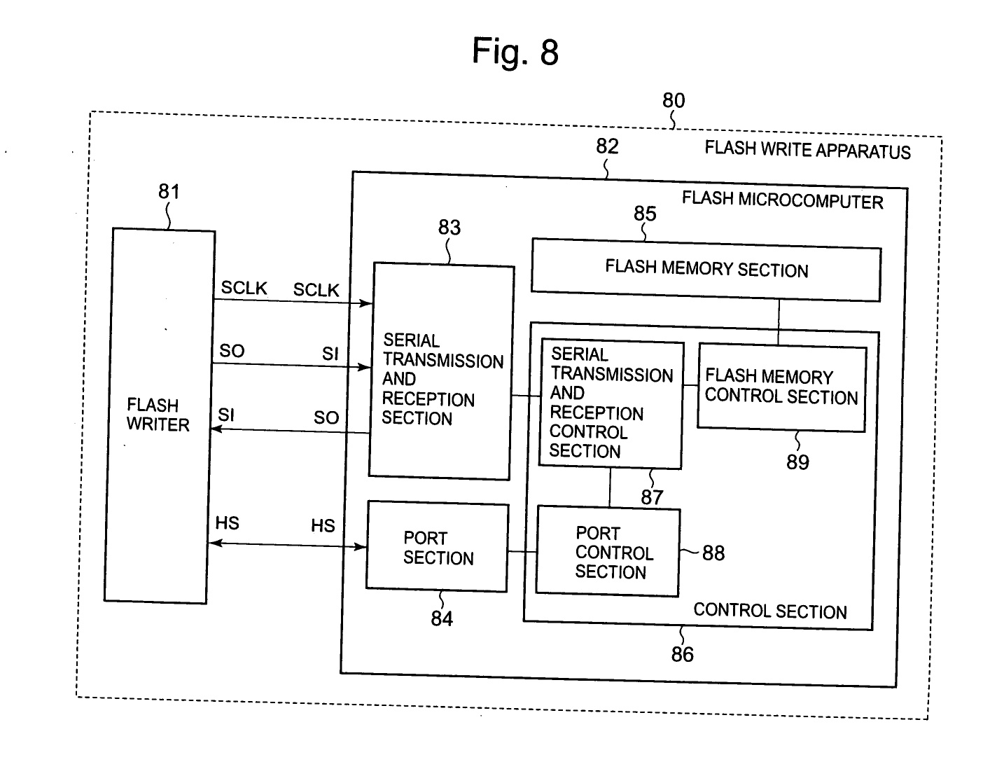

FIG. 9 shows a connection relationship between a conventional slave device 90 and a conventional master device 91;

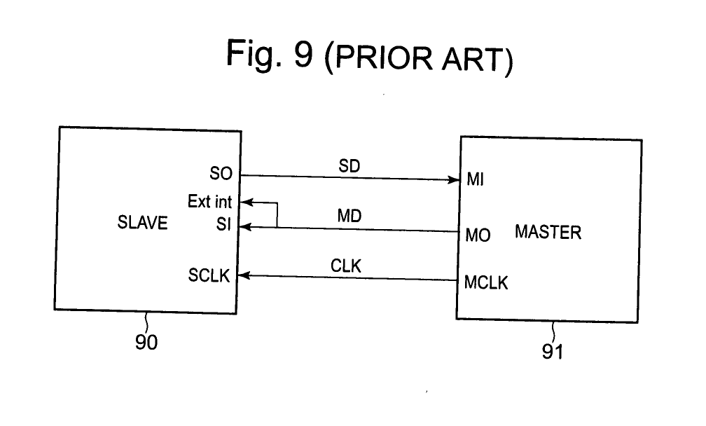

FIG. 10 is a timing chart in the case where data is transmitted from the conventional slave device 90 to the conventional master device 91; and

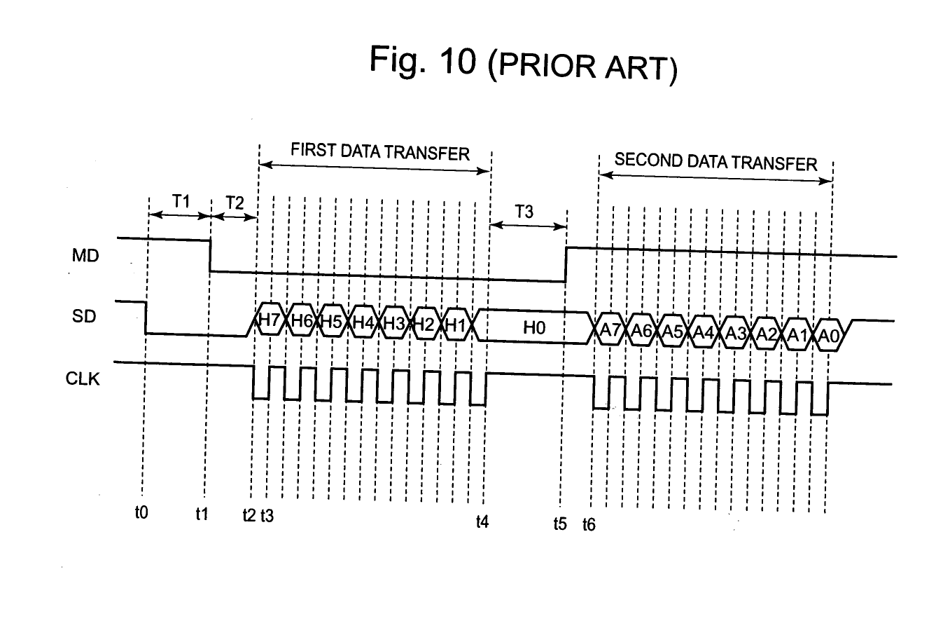

FIG. 11 is a timing chart in the case where data is transmitted from the conventional master device 91 to the conventional slave device 90.

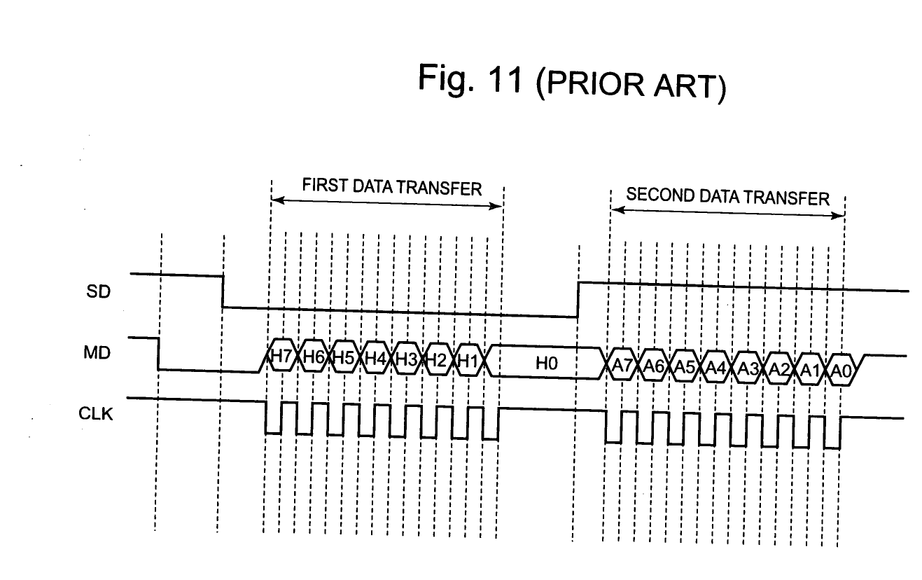

### DETAILED DESCRIPTION OF THE PREFERRED EMBODIMENT

The invention will be now described herein with reference to illustrative embodiments. Those skilled in the art will recognize that many alternative embodiments can be accomplished using the teachings of present invention and that the invention is not limited to the embodiments illustrated for explanatory purposes.

Hereinafter, the present invention will be described with reference to a data writing system (data transfer system) which includes a microcomputer on which a flash memory is mounted (data processing apparatus) and a flash writer for transferring data to be written into the flash memory (data transmitting and receiving device). The flash memory may be another memory, for example, an EEPROM or a ferroelectric random access memory (FeRAM).

### First Embodiment

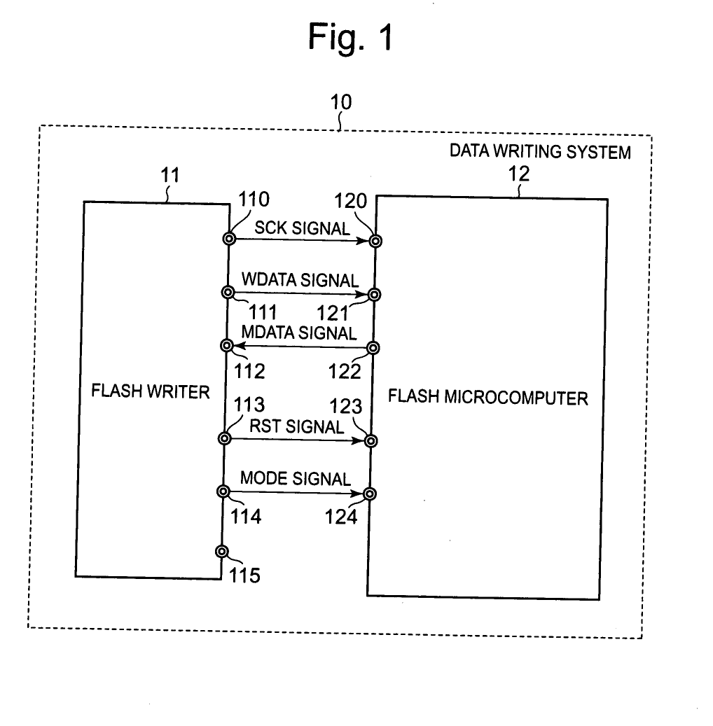

FIG. 1 is a block diagram showing a data writing system 10 according to a first embodiment of the present invention. As shown in FIG. 1, the data writing system 10 includes a flash writer 11 and a microcomputer (flash microcomputer) 12 on which a flash memory (not shown) is mounted (which contains the flash memory). The flash writer 11 is a device for writing data into the flash memory contained in the flash microcomputer 12.

The flash writer 11 has a WSCK terminal 110, a WSO terminal 111, a WSI terminal 112, a WOA terminal 113, a WOB terminal 114, and a WI terminal 115. The flash microcomputer 12 has an MSCK terminal 120, an MSI terminal 121, an MSO terminal 122, an MRST terminal 123, and an MMODE terminal 124.

The WSCK terminal 110 is connected with the MSCK terminal 120 through an SCK signal line. A serial clock (SCK signal) is transmitted from the flash writer 11 to the flash microcomputer 12 through the SCK signal line. The WSO terminal 111 is connected with the MSI terminal 121 through a WDATA line. A serial data signal (WDATA signal) is transmitted from the flash writer 11 to the flash microcomputer 12 through the WDATA line. The WSI terminal 112 is connected with the MSO terminal 122 through an MDATA line. A serial data signal (MDATA signal) is transmitted from the flash microcomputer 12 to the flash writer 11 through the MDATA line. The WOA terminal 113 is connected with the MRST terminal 123 through an RST signal line. A reset signal (RST signal) is transmitted from the flash writer 11 to the flash microcomputer 12 through the RST signal line. The WOB terminal 114 is connected with the MMODE terminal 124 through an MODE signal line. An operation mode set signal (MODE signal) is transmitted from the flash writer 11 to the flash microcomputer 12 through the MODE signal line.

The WI terminal 115 is a data input terminal for inputting, to the flash writer 11, write data which is data to be written, or the like into the flash memory contained in the flash microcomputer 12. A handshake leased line is not provided between the flash writer 11 and the flash microcomputer 12.

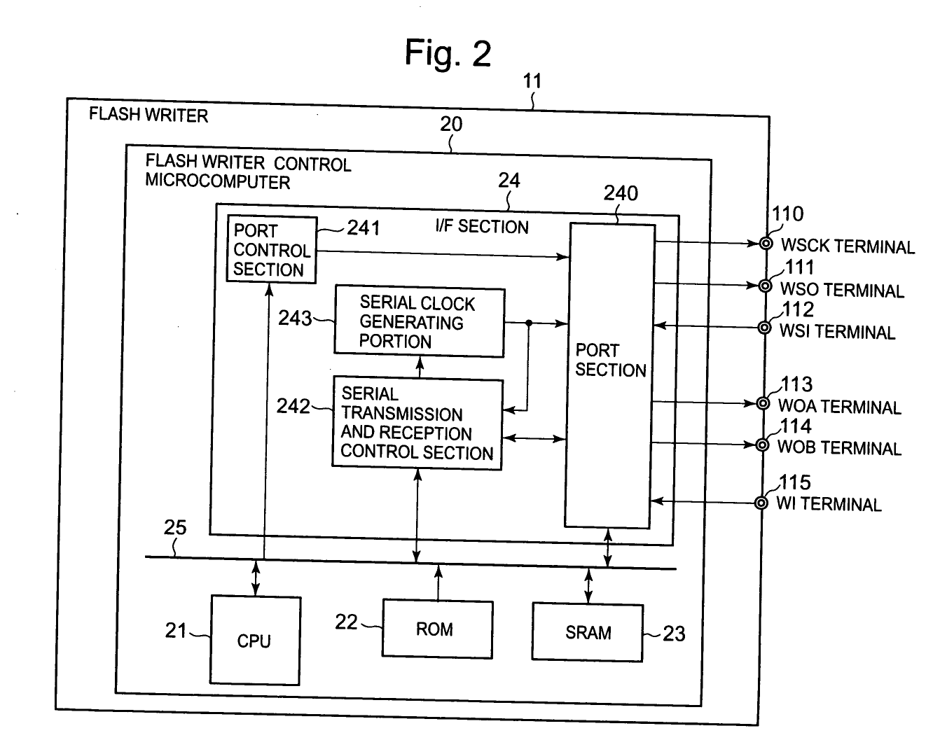

Next, the flash writer 11 will be described in detail with reference to FIG. 2. FIG. 2 is a,block diagram showing the flash writer 11 of the first embodiment of the present invention. The flash writer 11 includes a flash writer control microcomputer (micon) 20 connected with the six terminals shown in FIG. 1. The flash writer control microcomputer 20 includes a central processing unit (CPU) 21, a read only memory (ROM) 22, a static random access memory (SRAM) 23, an interface (I/F) section 24, and a bus 25.

The CPU 21 is connected with the bus 25 and can access the ROM 22, the SRAM 23, and the I/F section 24 through the bus 25.

The ROM 22 is connected with the bus 25. The ROM 22 stores a program for controlling the flash writer 11. The program is read by the CPU 21 and executed thereby to control the flash memory 11.

The SRAM 23 is connected with the bus 25. The SRAM 23 is used to store data input from an input terminal such as the WI terminal 115 and store programs read out from the ROM 22 by the CPU 21.

The I/F section 24 is connected with the bus 25 and the six terminals shown in FIG. 1. The I/F section 24 includes a port section 240, a port control section 241, a serial transmission and reception control section 242, and a serial clock generating portion 243, each of which is a sub-block.

The port section 240 is connected with the six terminals shown in FIG. 1. The flash writer control microcomputer 20 has respective terminals which can be used as general-purpose terminals. The “general-purpose” means that a predetermined terminal can be selected and used as, for example, an input terminal, an output terminal, or an input and output terminal. In addition, the “general-purpose” means that the predetermined terminal can be used as a serial clock output terminal, a serial data output terminal, or a serial data input terminal in the case of serial communication. The port section 240 is connected with the port control section 241. Terminal setting of the flash writer control microcomputer 20 is performed based on a control signal output from the port control section 241. The port control section 241 has a function for maintaining an output from the predetermined terminal set as the output terminal at a specific logic level in response to a control signal output from the port control section 241. For example, when the WOA terminal 113 is set as the output terminal, an output from the WOA terminal 113 can be held to the “H” level or changed from the “H” level to the “L” level.

The port control section 241 outputs, to the port section 240, control signals for setting the respective terminals of the flash writer control microcomputer 20 and controlling logic levels of output signals. The port control section 241 is connected with the bus 25. Signals output from the port control section 241 are controlled based on instructions from the CPU 21.

The serial transmission and reception control section 242 is connected with the bus 25 and the port section 240 and controls serial communication in the case where a terminal of the flash writer control microcomputer 20 is set as a serial communication terminal. To be specific, serial data which is transmitted from the flash microcomputer 12 and input from the port section 240 is captured in synchronization with the serial clock. The captured serial data is converted into parallel data of plural bits and output to the CPU 21 or the SRAM 23. Parallel data of plural bits which is input from the CPU 21 or the SRAM 23 is converted into serial data and output to the flash microcomputer 12 through the port section 240 in synchronization with the serial clock. Data parallel/serial (serial/parallel) conversion can be performed by, for example, a shift register.

The serial clock generating portion 243 is connected with the port section 240 and the serial transmission and reception control section 242. The serial clock generating portion 243 generates the serial clock in response to a control signal from the serial transmission and reception control section 242 and outputs the generated serial clock to the port section 240 and the serial transmission and reception control section 242.

In the case of FIG. 2, the program for controlling the flash writer 11 is stored in the ROM 22. However, the present invention is not limited to this case. For example, the program may be stored in a rewritable nonvolatile memory such as a flash memory. The SRAM 23 is used to temporarily store data. However, the present invention is not limited to this. For example, a dynamic random access memory (DRAM) may be used.

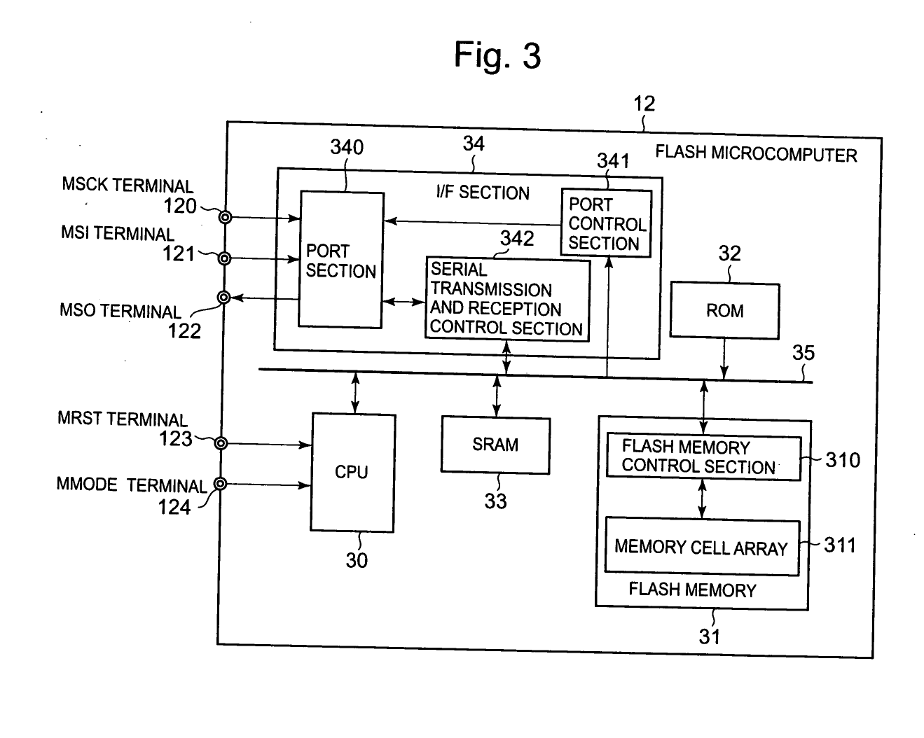

The flash microcomputer 12 will be described in detail with reference to FIG. 3. FIG. 3 is a block diagram showing the flash microcomputer 12 of the first embodiment of the present invention. The flash microcomputer 12 includes a CPU 30, a flash memory 31, a ROM 32, an SRAM 33, an I/F section 34, and a bus 35 in addition to the five terminals shown in FIG. 1.

The CPU 30 is connected with the bus 35 and can access the flash memory 31, the ROM 32, the SRAM 33, and the I/F section 34 through the bus 35. The CPU 30 is connected with the MRST terminal 123 and the MMODE terminal 124. The CPU 30 performs reset processing (initialization processing) on the flash microcomputer 12 in response to the RST signal input through the MRST terminal 123. The CPU 30 sets an operation mode of the flash microcomputer 12 based on the MODE signal input through the MMODE terminal 124. The operation mode of the flash microcomputer 12 includes a normal operation mode in which the flash microcomputer 12 is operated by a user system and a write operation mode in which the flash microcomputer 12 is connected with the flash writer 11 to write data into the flash memory 31.

The flash memory 31 is connected with the bus 35 and stores write data transmitted from the flash writer 11. The flash memory 31 includes a flash memory control section 310 and a memory cell array 311, each of which is a sub-block. The flash memory control section 310 executes various processings including writing, reading, and erasing of data in the memory cell array 311.

The ROM 32 is connected with the bus 35. The ROM 32 stores a program for controlling the operation of the flash microcomputer 12. The program is read by the CPU 30 and executed thereby to control the operation of the flash microcomputer 12. The ROM 32 further stores a program (firmware) for controlling writing, reading, and erasing in the flash memory 31. The flash memory control section 310 executes processing such as the writing in the memory cell array 311 based on the firmware.

The SRAM 33 is connected with the bus 35. The SRAM 33 is used to temporarily store the write data, an address indicating a write destination, and various commands (hereinafter referred to as write data and the like) which are received by the flash microcomputer 12 from the flash writer 11 through the I/F section 34, is used to store programs read out from the ROM 32 by the CPU 30.

The I/F section 34 is connected with the bus 35 and the three terminals (MSCK terminal 120, MSI terminal 121, and MSO terminal 122) shown in FIG. 1. The I/F section 34 includes a port section 340, a port control section 341, and a serial transmission and reception control section 342, each of which is a sub-block.

The port section 340 is connected with the three terminals shown in FIG. 1. As in the case of the port section 240 in the flash writer control microcomputer 20 shown in FIG. 2, settings (terminal type and logic level of output signal) of the three terminals connected with the port section 340 are performed by the port control section 341.

The functions of the port control section 341 and the serial transmission and reception control section 342 are fundamentally identical to the port control section 241 and the serial transmission and reception control section 242 in the flash writer control microcomputer 20 shown in FIG. 2. The serial clock is generated by only the flash writer 11, so the serial transmission and reception control section 342 receives the serial clock transmitted from the flash writer 11 and controls serial communication in synchronization with the received serial clock.

As in the case of FIG. 2, the present invention is not limited to the ROM 32 and the SRAM 33 in FIG. 3.

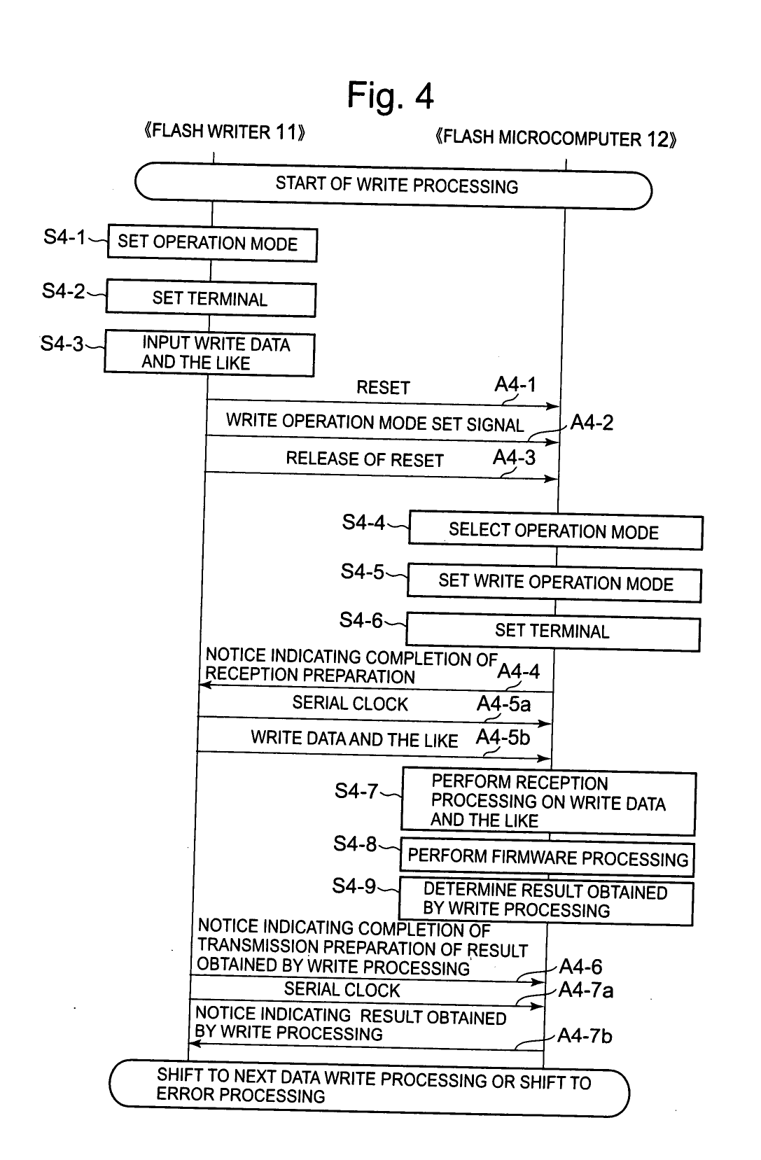

Next, the operation of the data writing system 10 according to the first embodiment of the present invention will be described with reference to FIG. 4. FIG. 4 is a flowchart showing operations of the flash writer 11 and the flash microcomputer 12 in the first embodiment of the present invention. FIG. 4 shows only processings of the flash writer 11 and the flash microcomputer 12 which are related to the case where data transfer is performed once.

First, in Step S4-1, an operation mode of the flash writer 11 is set. To be specific, the CPU 21 reads out the program for controlling the flash writer 11 from the ROM 22 and executes the read out program, so the flash writer 11 is shifted to a state where the flash memory 11 can be operated as a flash writer. When the operation mode is set, the subsequent operation of the flash writer 11 is controlled based on the programs stored in the ROM 22. With respect to the execution of the programs, the programs read out from the ROM 22 may be temporarily stored in the SRAM 23 and then read out from the SRAM 23 and executed.

In Step S4-2, the CPU 21 performs the setting of the terminals of the flash writer 11. To be specific, the following setting is performed by the CPU 21 through the port section 240 and the port control section 241. The WSCK terminal 110 is set as an output terminal for outputting the serial clock (SCK signal) The WSO terminal 111 is set as an output terminal for outputting the WDATA signal which is serial data. The WSI terminal 112 is set as an input terminal for inputting the MDATA signal which is serial data. The WOA terminal 113 is set as an output terminal for outputting the RST signal. The WOB terminal 114 is set as an output terminal for outputting the MODE signal. The WI terminal 115 is set as an input terminal for inputting the write data and the like to be transferred to the flash microcomputer. The initial state level of each of the output terminals which are the WSCK terminal 110, the WSO terminal 111, the WOA terminal 113, and the WOB terminal 114 is set to the “H” level.

In Step S4-3, the write data and the like to be transferred to the flash microcomputer 12 is input from an outside through the WI terminal 115. The input write data and the like are stored in the SRAM 23. The processing of Step S4-3 may be performed before the processing of Step S4-1 or the processing of Step S4-2. In such a case, it is necessary to set the WI terminal 115 as a specific input terminal to which the write data and the like can be input or set the WI terminal 115 as an input terminal in an initial state of the flash writer 11 after the power-on thereof.

In Step A4-1, the flash writer 11 transmits a signal for resetting the flash microcomputer 12. To be specific, the CPU 21 changes the output of the WOA terminal 113 from the “H” level to the “L” level through the port section 240 and the port control section 241 to transmit the RST signal of the “L” level to the flash microcomputer 12. The flash microcomputer 12 receives the RST signal of the “L” level from the MRST terminal 123 to perform the reset processing (initialization processing) on the internal blocks.

In Step A4-2, the flash writer 11 transmits a signal for setting a write operation mode (write operation mode set signal) to the flash microcomputer 12. To be specific, the CPU 21 changes the output of the WOB terminal 114 from the “H” level to the “L” level through the port section 240 and the port control section 241 to transmit the MODE signal of the “L” level to the flash microcomputer 12. The flash microcomputer 12 receives the MODE signal of the “L” level from the MMODE terminal 124.

In Step A4-3, the flash writer 11 transmits a signal for releasing a reset state of the flash microcomputer 12 which is obtained by the reset processing executed in Step A4-1. To be specific, the CPU 21 changes the output of the WOA terminal 113 from the “L” level to the “H” level through the port section 240 and the port control section 241 to transmit the RST signal of the “H” level to the flash microcomputer 12. Therefore, the reset state of the flash microcomputer 12 is released.

In Step S4-4, the flash microcomputer 12 selects the operation mode. To be specific, the CPU 30 checks a logic level of the MODE signal input to the MMODE terminal 124 at a timing of a rising edge of the RST signal (at a time when rest state is released) input from the MRST terminal 123. When the logic level of the MODE signal is the “H” level, the normal operation mode is selected by the CPU 30. When the logic level of the MODE signal is the “L” level, the write operation mode is selected by the CPU 30. At this time, the input MODE signal is in the “L” level, so the CPU 30 selects the write operation mode.

In Step S4-5, the operation mode of the flash microcomputer 12 is set. To be specific, the CPU 30 reads out a program corresponding to the write operation mode from the ROM 32 and executes the program. Upon receiving data transferred from the flash writer 11, the flash microcomputer 12 is shifted to a state in which the write operation can be performed on the flash memory 31. When the write operation mode is set, the subsequent operation of the flash microcomputer 12 is controlled based on the programs stored in the ROM 32. As in the case of the flash writer 11, with respect to the execution of the programs, the programs read out from the ROM 32 may be temporarily stored in the SRAM 33 and then read out from the SRAM 33 and executed.

In Step S4-6, the CPU 30 performs the setting of the terminals of the flash microcomputer 12. To be specific, the following setting is performed by the CPU 30 through the port section 340 and the port control section 341. The MSCK terminal 120 is set as an input terminal for inputting the serial clock (SCK signal). The MSI terminal 121 is set as an input terminal for inputting the WDATA signal which is serial data. The MSO terminal 122 is set as an output terminal for outputting the MDATA signal which is serial data. The initial state level of the output terminal of the MSO terminal 122 is set to the “H” level.

When the setting of the operation mode of the flash microcomputer 12 and the setting of the terminals thereof are completed, in Step A4-4, the flash microcomputer 12 transmits a notice signal indicating that the reception preparation of the write data and the like are completed to the flash writer 11. To be specific, the CPU 30 changes the output of the MSO terminal 122 from the “H” level to the “L” level through the port section 340 and the port control section 341 to transmit a falling edge signal of the MDATA signal to the flash writer 11. As a result, the flash writer 11 recognizes that the reception preparation of the flash microcomputer 12 is completed.

In Step A4-5a, the flash writer 11 transmits the serial clock to the flash microcomputer 12 in response to the falling edge signal of the MDATA signal which is transmitted in Step A4-4. In Step A4-5b, the flash writer 11 transmits the write data and the like to the flash microcomputer 12 in synchronization with the serial clock. To be specific, the CPU 21 detecting the falling edge signal of the MDATA signal reads out the write data and the like stored in the SRAM 23 and instructs the serial transmission and reception control section 242 to perform serial communication. The serial transmission and reception control section 242 outputs the control signal to the serial clock generating portion 243 to generate the serial clock. The serial clock generated by the serial clock generating portion 243 is output to the serial transmission and reception control section 242 and the port section 240. The serial transmission and reception control section 242 performs parallel/serial conversion on the write data and the like in synchronization with the serial clock and outputs the converted write data and the like to the port section 240. The port section 240 transmits the input the serial clock and the input serial write data and the like as the SCK signal and the WDATA signal to the flash microcomputer 12 through the WSCK terminal 110 and the WSO terminal 111.

In Step S4-7, the flash microcomputer 12 performs reception processing on the write data and the like. To be specific, the write data and the like input from the MSI terminal 121 is input to the serial transmission and reception control section 342 through the port section 340. The serial transmission and reception control section 342 performs serial/parallel conversion on the serial write data and the like to generate a parallel write data and the like and outputs the parallel write data and the like to the SRAM 33. The write data and the stored in the SRAM 33 is read out by the CPU 30. Whether or not the data transfer is normally performed is checked based on checksum data included in the read out write data and the like. In addition to this, the type of the received write data and the like are determined. That is, the write data and the like transmitted from the flash writer 11 includes address data for designating an address of the memory cell array 311 into which data is written and various commands (such as erasing command and write command) as well as the write data actually written into the flash memory 31, so the CPU 30 determines the contents of the received write data and the like.

In Step S4-8, the firmware processing, that is, processing including writing is performed. To be specific, the CPU 30 reads out, from the ROM 32, firmware for controlling the access to the flash memory 31 and executes the read out firmware. The subsequent write processing is controlled based on the firmware. The CPU 30 reads out the write data and the like from the SRAM 33 and outputs the read out write data and the like to the flash memory control section 310. The flash memory control section 310 writes the write data and the like into a predetermined address of the memory cell array 311. After the completion of the data writing, verify processing is performed to compare the written data with an expected value.

In Step S4-9, the flash microcomputer 12 determines whether or not the processing of each of Steps S4-7 and S4-8 can be normally performed to complete the write processing of the write data transmitted from the flash writer 11 into the flash memory 31 (determines result obtained by the write processing). When a checksum error is not detected in Step S4-7 and a result obtained by the verify processing match in Step S4-8, it is determined that the writing into the flash memory 31 is normally performed.

In Step A4-6, the flash microcomputer 12 notifies, to the flash writer 11, a transmission preparation completion notice indicating that the transmission preparation of the result obtained in Step S4-9 to the flash writer 11 is completed. To be specific, the CPU 30 changes the output of the MSO terminal 122 from the “L” level to the “H” level through the port section 340 and the port control section 341 to transmit the rising edge signal of the MDATA signal to the flash writer 11. Therefore, the flash writer 11 recognizes that the transmission preparation of the flash microcomputer 12 is completed to request the transmission of the serial clock.

In Step A4-7a, the flash writer 11 transmits the serial clock to the flash microcomputer 12 in response to the rising edge signal of the MDATA signal which is transmitted in Step A4-6. In Step A4-7b, the flash microcomputer 12 transmits response data to the flash writer 11 in synchronization with the received serial clock. To be specific, the CPU 21 detecting the rising edge signal of the MDATA signal instructs the serial transmission and reception control section 242 to transmit the serial clock. The serial transmission and reception control section 242 outputs the control signal to the serial clock generating portion 243 to generate the serial clock. The serial clock generated by the serial clock generating portion 243 is output to the port section 240. The port section 240 transmits the input the serial clock to the flash microcomputer 12 through the WSCK terminal 110. The serial clock input from the MSCK terminal 120 is input to the serial transmission and reception control section 342 through the port section 340. The serial transmission and reception control section 342 performs parallel/serial conversion on the response data (result in step S4-9) output from the CPU 30 and outputs serial response data to the port section 340. The serial response data input to the port section 340 is transmitted as the MDATA signal to the flash writer 11 through the MSO terminal 122. The serial response data input from the WSI terminal 112 is input to the serial transmission and reception control section 242 through the port section 240. The serial transmission and reception control section 242 obtains the serial response data in synchronization with the serial clock input from the serial clock generating section 243. Then, serial transmission and reception control section 242 performs serial/parallel conversion on the obtained serial response data to generate parallel response data and outputs the generated parallel response data to the CPU 21. Therefore, the CPU 21 can check the response data to determine whether or not the write processing of the write data transmitted in Step A4-5b is normally performed. When a result of the response data indicates the completion of the normal write processing, processing is shifted to next processing related to the write data. On the other hand, when the response data indicates an error, error processing including the retransmission of the write data and the like are executed.

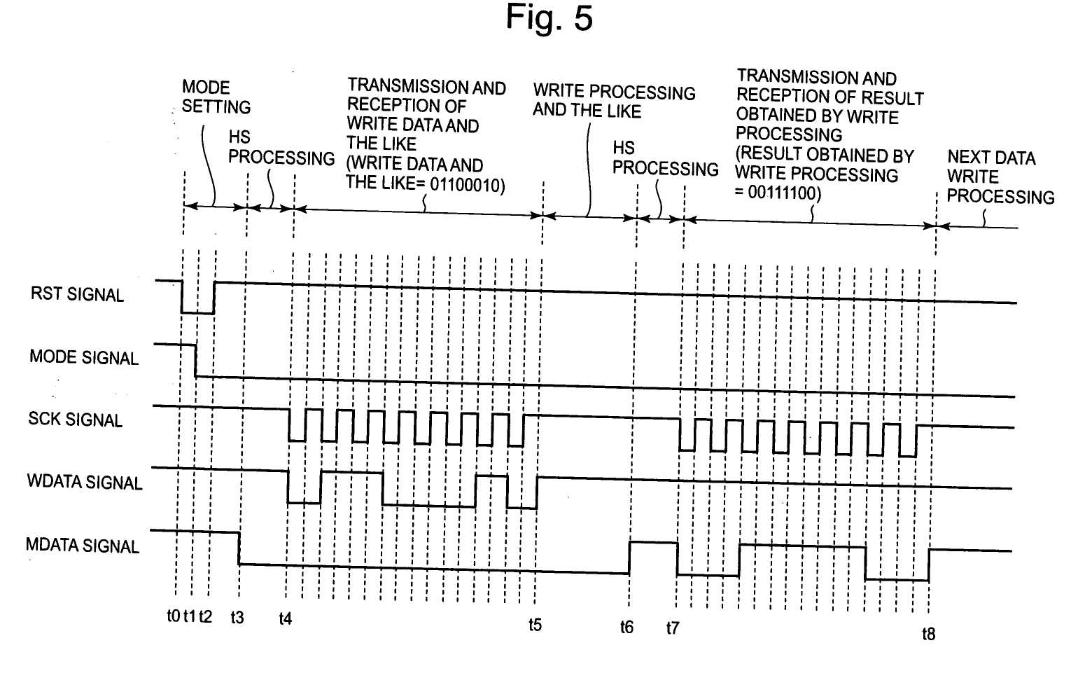

Next, timings of signals transmitted and received between the flash writer 11 and the flash microcomputer 12 will be described with reference to timing charts shown in FIGS. 5 to 7. In FIGS. 5 to 7, a size of data transmitted and received between the flash writer 11 and the flash microcomputer 12 is eight bits. However, the present invention is not limited to this size.

FIG. 5 is a timing chart showing signals transmitted and received between the flash writer 11 and the flash microcomputer 12 of the first embodiment of the present invention (in the case where normal writing is performed). In FIG. 5, assume that the write data and the like transmitted from the flash writer 11 to the flash microcomputer 12 are set to “01100010” and the response data indicating that the write data and the like transmitted from the flash microcomputer 12 to the flash writer 11 is normally written is set to “00111100”.

A period between a time t0 and a time t3 is a period for setting the operation mode of the flash microcomputer 12. At the time t0, the level of the RST signal is changed from the “H” level to the “L” level to reset the flash microcomputer 12. During the period between the time t0 and the time t2 in which the RST signal is in the “L” level, the flash microcomputer 12 is maintained at a reset state. At the time t1, the flash writer 11 changes the level of the MODE signal from the “H” level to the “L” level to set the write operation mode to the flash microcomputer 12. At the time t2, the RST signal is changed from the “L” level to the “H” level, so the reset state of the flash microcomputer 12 is released and the flash microcomputer 12 is shifted to the write operation mode based on the “L” level of the MODE signal.

A period between the time t3 and a time t4 is a period during which handshake (HS) communication processing for starting the transfer of the write data and the like are performed between the flash writer 11 and the flash microcomputer 12. At the time t3, in order to send, to the flash writer 11, a notice indicating that the flash microcomputer 12 is in a state in which the write data and the like can be received, the flash microcomputer 12 changes the level of the MDATA signal from the “H” level to the “L” level to generate the falling edge signal and transmits the generated falling edge signal to the flash writer 11. The flash writer 11 receives the falling edge signal to determine that the flash microcomputer 12 is already in the receivable state. At the time t4, in response to the falling edge signal of the MDATA signal, the flash writer 11 transmits the serial cock as the SCK signal and starts serial communication of the write data and the as the WDATA signal.

A period between the time t4 and a time t5 is a period during which the write data and the like are transmitted from the flash writer 11 and received by the flash microcomputer 12. The WDATA signal is transmitted from the flash writer 11 in synchronization with a falling edge of the SCK signal. The flash microcomputer 12 receives the WDATA signal at a rising edge of the SCK signal. During this period, the transmission and reception of eight-bit serial data of “01100010” is performed. The flash writer 11 sets the level of the WDATA signal to the “H” level at the time t5 after the transmission of the write data and the like.

A period between the time t5 and a time t6 is a period during which the flash microcomputer 12 checks the presence or absence of a communication error of the received write data and the like, checks the contents of the received write data and the, and determines whether or not a series of write processings including the write processing to the flash memory 31 and the verify processing of the written data are normally performed. The checking and the determination are performed in the inner portion of the flash microcomputer 12, so data communication between the flash writer 11 and the flash microcomputer 12 is not performed during the period.

A period between the time t6 and a time t7 is a period during which handshake (HS) communication processing for starting the transfer of the response data indicating whether or not the series of write processings are normally performed is carried out between the flash writer 11 and the flash microcomputer 12. At the time t6, in order to send, to the flash writer 11, a notice indicating that the flash microcomputer 12 is in a state in which the response data can be transmitted, the flash microcomputer 12 changes the level of the MDATA signal from the “L” level to the “H” level to generate the rising edge signal and transmits the generated rising edge signal to the flash writer 11. The flash writer 11 receives the rising edge signal to determine that the flash microcomputer 12 is already in a transmittable state. At the time t7, the flash writer 11 starts transmitting the serial cock as the SCK signal in response to the rising edge signal of the MDATA signal. The flash microcomputer 12 starts transmitting the response data to the flash writer 11 in synchronization with the serial clock.

A period between the time t7 and a time t8 is a period during which the response data is transmitted from the flash microcomputer 12 to the flash writer 11. The MDATA signal is transmitted from the flash microcomputer 12 in synchronization with the falling edge of the SCK signal. The flash writer 11 receives the MDATA signal at the rising edge of the SCK signal. During this period, the transmission and reception of eight-bit serial data of “00111100” is performed. The flash microcomputer 12 sets the level of the MDATA signal to the “H” level at the time t8 after the transmission of the response data.

FIG. 5 shows that the response data is normally written during the period between the time t7 and the time t8, so next data write processing is performed during a period after the time t8.

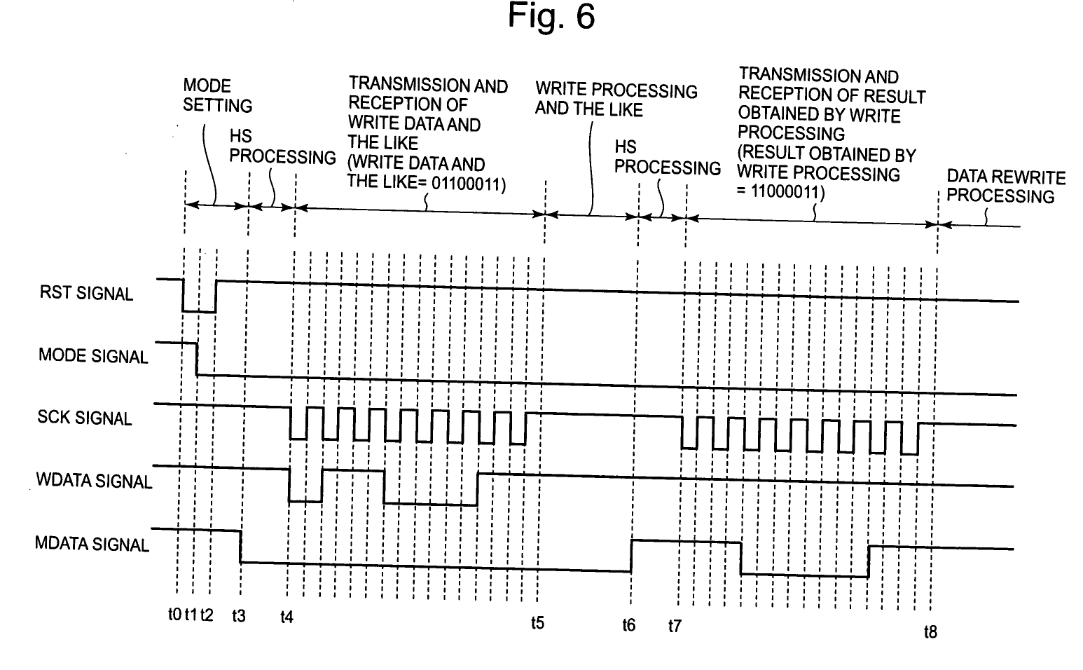

FIG. 6 is a timing chart showing signals transmitted and received between the flash writer 11 and the flash microcomputer 12 in the first embodiment of the present invention (in the case where the normal writing is not performed). In FIG. 6, assume that the write data and the like transmitted from the flash writer 11 to the flash microcomputer 12 is set to “01100011” and the response data indicating that the write data and the like transmitted from the flash microcomputer 12 to the flash writer 11 is not normally written is set to “11000011”.

FIG. 6 is different from FIG. 5 only in differences of the write data and the like and the response data, so timings of changed signals as shown in FIG. 6 are fundamentally identical to those in the case of FIG. 5. Note that the response data shown in FIG. 6 indicates that the normal writing is not performed, so the processing after the time t8 is shifted to error processing. Specific possible examples of the error processing include the case where the same write data and the like are transferred to the flash microcomputer 12 again to perform rewrite processing and the case where processing for giving an alarm (signal) from the flash writer 11 to a user through an output terminal (not shown) is performed without the write processing.

With respect to the response data indicating that the normal writing is not performed, response data to be prepared may be changed for each cause and transmitted to the flash writer 11. The following different applications may be employed. For example, when the write data and the like are not normally transmitted from the flash writer 11 to the flash microcomputer 12 and error write processing is caused, the response data is set to “11100011”. When the write data and the like are normally transmitted from the flash writer 11 to the flash microcomputer 12 but an error occurs at the time of writing to the flash memory 31 (verification error occurs), the response data is set to “11000011”.

Whether or not a communication error such as a checksum error occurs may be checked for the response data. Therefore, when the communication error occurs in the response data, the flash writer 11 can request again the transmission of the response data to the flash microcomputer 12.

FIG. 6 is different from FIG. 5 in that the logic of final serial data transmitted from each of the flash writer 11 and the flash microcomputer 12 is “1” (“H” level), so the processing corresponding to the processing for changing from the “L” level to the “H” level at the time t5 or t8 in FIG. 5 is unnecessary. In addition, the processing for changing the level of the WDATA signal from the “L” level to the “H” level at the time t5 in FIG. 5 is not necessarily performed. However, the processing for changing the level of the MDATA signal from the “L” level to the “H” level at the time t8 in FIG. 5 is necessary because the MDATA signal itself is used for handshake processing.

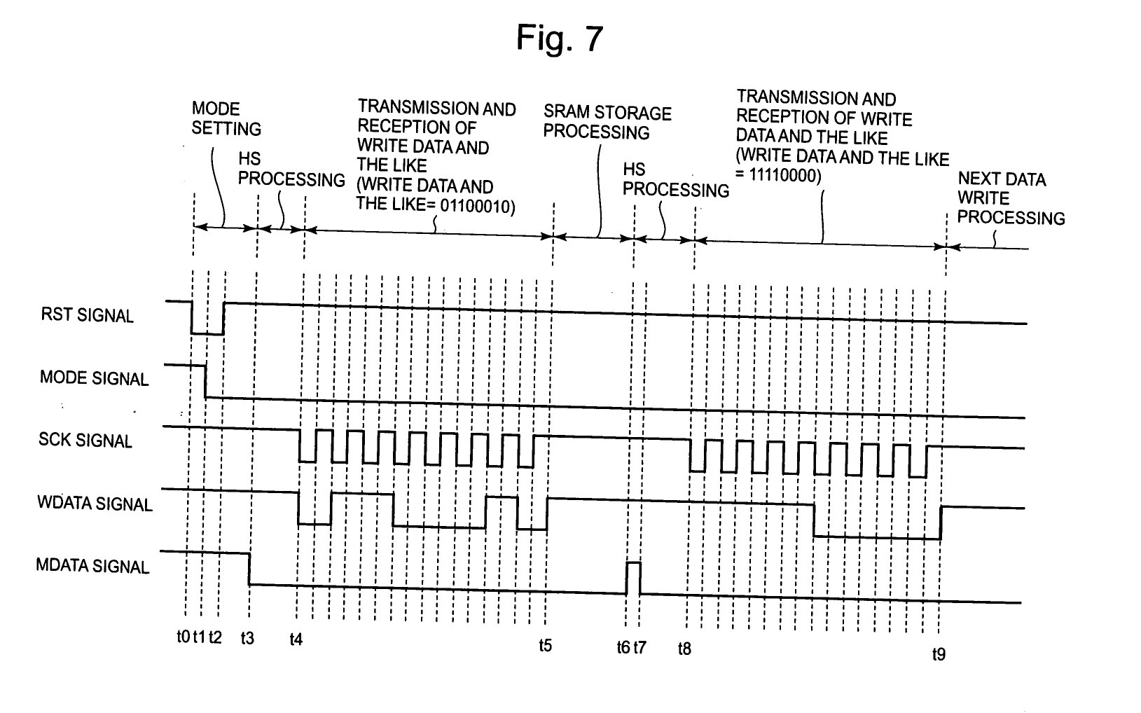

FIG. 7 is a timing chart showing signals transmitted and received between the flash writer 11 and the flash microcomputer 12 according to the first embodiment of the present invention (in the case where write data and the like are successively transmitted). As shown in FIG. 7, two kinds of write data and the like (“01100010” and “11110000” ) are successively transmitted from the flash writer 11 to the flash microcomputer 12. During the period between the time t5 and the time t6, the flash microcomputer 12 performs not write processing but processing such as storing the received write data and the like in the SRAM 33.

As described above, when the write data and the like are transmitted from the flash writer 11 to the flash microcomputer 12, the falling edge signal of the MDATA signal is used as a handshake signal. On the other hand, when the response data is transmitted from the flash microcomputer 12 to the flash writer 11, the rising edge signal of the MDATA signal is used as a handshake signal. In other words, in the example shown in FIG. 7, when the MDATA signal after first transmission of the write data and the like of “01100010” is held at the “L” level, the falling edge signal of the MDATA signal which is required for second transmission of the write data and the like of “11110000” cannot be generated. Therefore, the level of the MDATA signal is temporarily changed from the “L” level to the “H” level at the time t6 in FIG. 7 and then changed again from the “H” level to the “L” level at the time t7. Even in the case of FIG. 5, because of the same reason, when the level of the MDATA signal is not changed from the “L” level to the “H” level at the time t8 in FIG. 5, a handshake signal cannot be generated for next data transmission and reception processing performed after the time t8. Note that a timing of changing from the “L” level to the “H” level is not necessarily the time t8 and may be any timing as long as it does not affect next data write processing.

Therefore, according to the first embodiment of the present invention, when the write data and the like are transferred from the flash writer 11 to the flash microcomputer 12, the falling edge signal of the MDATA signal is used as the handshake signal (the trigger signal). On the other hand, when the response data is transferred from the flash microcomputer 12 to the flash writer 11, the rising edge signal of the MDATA signal is used as the handshake signal (the trigger signal). That is, in data transmission and reception between the flash writer 11 and the flash microcomputer 12 after the flash microcomputer 12 is shifted to the write operation mode in response to the signal from the flash writer 11, the data transfer is realized using a single signal line which is the MDATA line through which the MDATA signal is transmitted. In the case of write processing to the nonvolatile-memory-contained microcomputer using the above data transfer system, the data transfer system for the write data is simpler than the conventional system (data transfer system using the two signal lines (data lines SD and MD) in the case of data transmission and reception because the handshake signal is output from the reception side). Therefore, the control (processing) of the data transfer in the present invention is facilitated. Thus, a time for the write processing to the nonvolatile-memory-contained microcomputer can be shortened.

Although the inventions has been described above in connection with several preferred embodiments thereof, it will be appreciated by those skilled in the art that those embodiments are provided solely for illustrating the invention, and should not be relied upon to construe the appended claims in a limiting sense. In the case of FIG. 5, when an initial value of each of the WDATA signal and the MDATA signal at the time t0 is set to the “L” level, a handshake edge signal of the MDATA signal at the time t3 may be changed to a rising edge signal and a handshake edge signal of the MDATA signal at the time t8 may be changed to a falling edge signal.

What is claimed is:

1. A data transfer method for a data transfer system which includes a transceiver and a data processing apparatus coupled to the transceiver through a first line, a second line, and a third line, the method comprising:
performing a first data transfer from the transceiver to the data processing apparatus, including;
transmitting a first trigger signal from the data processing apparatus to the transceiver through the first line,
transmitting a first clock signal from the transceiver to the data processing apparatus through the second line in response to the first trigger signal, and
transmitting a first transfer data from the transceiver to the data processing apparatus through the third line in synchronization with the first clock signal; and
performing a second data transfer from the data processing apparatus to the transceiver, including;
transmitting a second trigger signal from the data processing apparatus to the transceiver through the first line,
transmitting a second clock signal from the transceiver to the data processing apparatus through the second line in response to the second trigger signal, and
transmitting a second transfer data from the data processing apparatus to the transceiver through the first line in synchronization with the second clock signal.

2. The data transfer method according to claim 1, wherein performing the first data transfer further includes capturing, in synchronization with the first clock signal received through the second line, the first transfer data received through the third line.

3. The data transfer method according to claim 2, wherein performing the first data transfer further includes writing the captured first transfer data into a memory mounted on the data processing apparatus.

4. The data transfer method according to claim 3, further comprising:
transmitting the second transfer data indicating that the normal writing is completed from the data processing apparatus to the transceiver in synchronization with the second clock signal when the normal writing to the memory is performed; and
transmitting,the second transfer data indicating that normal writing is not completed from the data processing apparatus to the transceiver in synchronization with the second clock signal when the normal writing to the memory is not performed.

5. The data transfer method according to claim 3, wherein the transceiver and the data processing apparatus are further coupled to each other through a fourth line and a fifth line and the data transfer method further comprises:
transmitting a reset signal from the transceiver to the data processing apparatus through the fourth line before the first trigger signal is transmitted from the data processing apparatus to the transceiver; and
changing an operation mode to a write operation mode based on a logic level on the fifth line while the reset signal is received in the data processing apparatus.

6. A data transfer method for a data transfer system which includes a transceiver and a data processing apparatus coupled to the transceiver through a first line, a second line, and a third line, the method comprising:
(a) transmitting a first trigger signal from the data processing apparatus to the transceiver through the first line;
(b) transmitting a first clock signal from the transceiver to the data processing apparatus through the second line in response to the first trigger signal;
(c) transmitting a first transfer data from the transceiver to the data processing apparatus through the third line in synchronization with the first clock signal;
(d) transmitting a second trigger signal from the data processing apparatus to the transceiver through the first line after the step (c);
(e) transmitting a second clock signal from the transceiver to the data processing apparatus through the second line in response to the second trigger signal; and
(f) transmitting a second transfer data from the data processing apparatus to the transceiver through the first line in synchronization with the second clock signal.

7. The data transfer method according to claim 6, wherein the data processing apparatus and the data processing apparatus perform handshake signal transmission and reception with each other without using the third terminal.

8. The data transfer method according to claim 6, wherein:
the first trigger signal includes a change from a first logic level to a second logic level; and
the second trigger signal includes a change from the second logic level to the first logic level.

9. The data transfer method according to claim 6, further comprising (g) writing the first transfer data into a memory mounted on the data processing apparatus before the step (d)

10. The data transfer method according to claim 9, wherein the step (f) comprises:
(h1) transmitting the second transfer data indicating that normal writing is completed when the step (g) is normally performed; and
(h2) transmitting the second transfer data indicating that the normal writing is not completed when the step (g) is not normally performed.

11. The data transfer method according to claim 9, wherein:
the transceiver and the data processing apparatus are further coupled to each other through a fourth line and a fifth line,; and
the data transfer method further comprises:
(i) transmitting a reset signal from the transceiver to the data processing apparatus through the fourth line before the step (a); and
(j) changing an operation mode to a write operation mode based on a logic level on the fifth line while the reset signal is received in the data processing apparatus.

12. A data processing apparatus, comprising:
a first terminal;
a second terminal; and
a third terminal, wherein:
the data processing apparatus is able to perform data transmission and reception with a transceiver through the first terminal, the second terminal, and the third terminal;
when data is received from the transceiver, the data processing apparatus is configured to:
output a first trigger signal from the first terminal;
receive, at the second terminal, a first clock signal output from the transceiver in response to the first trigger signal; and
receive, at the third terminal, a first transfer data output from the transceiver in synchronization with the first clock signal; and
when data is transmitted to the transceiver, the data processing apparatus is configured to:
output a second trigger signal from the first terminal;
receive, at the second terminal, a second clock signal output from the transceiver in response to the second trigger signal; and
output a second transfer data from the first terminal to the transceiver in synchronization with the received second clock signal.

13. The data processing apparatus according to claim 12, wherein the data processing apparatus perform handshake signal transmission and reception with the transceiver without using the third terminal.

14. The data processing apparatus according to claim 12, wherein:
the first trigger signal includes a change from a first logic level to a second logic level; and
the second trigger signal includes a change from the second logic level to the first logic level.

15. The data processing apparatus according to claim 12, further comprising an interface section coupled to the first terminal, the second terminal, and the third terminal,
wherein the interface section captures the first transfer data received through the third terminal in synchronization with the first clock signal received through the second terminal.

16. The data processing apparatus according to claim 15, wherein:
the interface section comprises a serial communication control section; and
the serial communication control section receives the first transfer data in a form of serial data to convert the first transfer data into parallel data.

17. The data processing apparatus according to claim 16, wherein the serial communication control section controls to transmit the second transfer data in the form of serial data from the first terminal in synchronization with the second clock signal input through the second terminal.

18. The data processing apparatus according to claim 15, further comprising:
a memory region; and
a memory control section for controlling data writing for the memory region,
wherein the memory control section writes, into the memory region, the first transfer data captured in synchronization with the first clock signal.

19. The data processing apparatus according to claim 18, further comprising:
a fourth terminal to which a reset signal output from the transceiver is input; and
a fifth terminal to which an operation mode set signal output from the transceiver is input,
wherein the data processing apparatus changes an operation mode to a write operation mode based on a logic level of the operation mode set signal when a logic level of the reset signal changes.

20. The data processing apparatus according to claim 18, wherein:
when the first transfer data captured in synchronization with the first clock signal is normally written into the memory region, the data processing apparatus is configured to transmit the second transfer data indicating that normal writing is completed; and
when the first transfer data captured in synchronization with the first clock signal is not normally written into the memory region, the data processing apparatus is configured to transmit the second transfer data indicating that the normal writing is not completed.
